(19) United States
(12) Patent Application Publication
(10) Pub. No.: US 2006/0100299 A1
(43) Pub. Date: May 11, 2006

(54) Transformable pressure sensitive adhesive tape and use thereof in display screens

(76) Inventors: Ranjit Malik, York, PA (US); Brian A Harkins, York, PA (US); David H Williams III, Harrisburg, PA (US)

Correspondence Address: BIRCH STEWART KOLASCH & BIRCH, PO BOX 747, FALLS CHURCH, VA, 22040-0747, US

(21) Appl. No.: 10/522,149

(22) PCT Filed: Jul. 18, 2003
(86) PCT No.: PCT/US03/22589

§ 371 Date: Sep. 29, 2005

(30) Foreign Application Priority Data
Jul. 24, 2002 (US) 60398026
Nov. 6, 2002 (US) 60424002

(51) Int. Cl. C08G 59/68; B29C 71/04

(52) U.S. Cl. 522/31; 522/71; 522/92

(57) ABSTRACT

A transformable pressure sensitive adhesive composition comprised of from about 15 to about 80% by weight of a polymer having a softening point greater than 60° C.; from about 20 to about 85% by weight of a polymerizable resin having a softening point less than 30° C.; a latent initiator in an amount sufficient to cause a reaction between said polymer and said resin; and optionally, a crosslinking agent. The transformable pressure sensitive adhesive has particular applicability in connection with organic light emitting diode display devices, light emitting diode display devices, medical diagnostic testing devices, flexible or rigid LCD display devices, plasma display devices, and electrochromic devices.

### BACKGROUND OF THE PRESENT INVENTION

Currently in the market place, there is a need for bonding materials that serve a multifunctional purpose. Materials are needed that not only bond and hold substrates together, but also provide additional benefits such as high mechanical shear, tensile strength, peel strength, chemical resistance, water resistance, plasticizer resistance, clean converting, moisture barrier and gas barrier, etc.

A pressure sensitive adhesive tape by definition is soft and tacky. It has moderate load bearing ability as compared to most liquid adhesives but provides the ease and convenience of use combined with its ability to stick quickly. It is an object of the present invention to incorporate chemistries in a pressure sensitive adhesive that can be triggered on demand, whereby the physical properties of the adhesive (high mechanical properties, chemical resistance, water resistance, barrier properties, etc.) become enhanced.

### BRIEF DESCRIPTION OF THE DRAWINGS

FIG. 1 depicts in cross-section a conventional OLED device.

FIG. 2 depicts in cross-section an OLED device of the invention.

### DETAILED DESCRIPTION OF THE INVENTION

The present invention is directed to a transformable pressure sensitive adhesive that exist in two states. In its first state, it is a pressure sensitive adhesive that forms instant bonds without the use of mechanical fasteners and has green strength to maintain the bond. Upon exposure to a suitable external trigger, it transforms into the second state whereupon the incorporated chemistries react, altering the chemical and physical nature of the material to meet one or more of the above mentioned benefits.

The ability to trigger transformation in the performance characteristics of a pressure sensitive adhesive expands the scope of application and fulfills presently unmet needs. For example, the modulus and strength bearing properties can be altered when desired. The glass transition temperature and softening point can be changed thereby altering the temperature resistance. The refractive index can be changed to alter its optical properties. The balance between the cohesive and adhesive properties can be shifted. The resistance to solvents and permeation of gases and vapors can be changed.

The adhesive of the present invention can be employed in connection with a variety of applications. Applications envisioned for this technology include, but are not limited to, the bonding of medical diagnostic devices where not only a rapid fixing of the parts is required but subsequent resistance of the bond to various chemical environments is also required. Moreover, as the adhesive may contaminate the analytical chemicals in the medical device, proper selection of the adhesive chemistry is essential. This technology also lends itself to clean die cuttability, a highly desired feature, for uninterrupted running of the manufacturing equipment.

An additional application for the adhesive of the present invention is for the encapsulation/packaging of delicate electronics (such as optical display devices) for the purpose of protecting them against the atmospheric elements. In particular, liquid crystal display (LCD), organic light emitting display (OLED), and plasma display screens lend themselves to use of the adhesive of the present invention. The adhesive may be used to form a rapid but temporary seal for the active electronics. The seal is subsequently triggered (transformed) and converted to a permanent bond to protect against oxygen, moisture, and mechanical damage. The resulting seal plays a crucial role in providing an acceptable lifetime for these devices. Another exemplary application is the sealing and protection of electrochromic (EC) devices. Importantly, the formation of a flexible seal by use of the adhesive of the present invention is well suited for the bonding of flexible LCD, OLEDS, and EC devices (comprised of flexible plastic substrates instead of rigid glass substrates).

Another application for the adhesive of the present invention is to splice fabrics, nonwovens, and plastics. A stitching process is normally used to sew these materials. However, the substrates become perforated during the stitching process, which is undesirable in situations where the migration of liquids, gases and biological agent through the seam is a disadvantage.

The prior art discusses a variety of adhesives which have been found to be unsatisfactory for such use.

U.S. Pat. No. 4,552,604 relates to a method for bonding together two surfaces selected from the group consisting of metals, ceramic or wood using a thermosettable epoxy/acrylate based pressure sensitive adhesive. The composition discloses a broad range of acrylate components. The hardener can be polycarboxylic acid anhydride, dicyandiamide, an imidazole, a latent boron difluoride chelate, an aromatic polyamine and a complex of an amine with boron trifluoride or trichloride. The adhesive is thermoset at a temperature of, for example, 170° C. for 1 hour (see Example 1).

U.S. Pat. No. 5,086,088 describes a thermosetting epoxy-acrylate based pressure sensitive adhesive, the acrylate component of which comprises 30% to 80% by weight of of photopolymerizable prepolymeric or monomeric syrup of acrylic esters. The hardener for the epoxide component is an amine hardener, and a curing temperature of, for example, 140° C. is applied for 20 to 40 minutes (see Example 41). The pressure sensitive adhesive tapes are proposed for use in the automotive industry in structural bonding of metal surfaces or for sealing of metal seams. The disclosed pressure sensitive thermosetting adhesive is limited to the use of prepolymeric or monomeric acrylic esters. The tape is made by a photopolymerization process. The material as described can only be triggered by heat and the use of amine type curing agents to trigger the transformation. Amine cures require high temperature and long cure time. Amine cure systems also suffer from a limited shelf life.

PCT application No. WO 95/13328 describes a thermosettable pressure sensitive adhesive comprising a polymerizable monomeric or prepolymeric syrup of acrylates and one or more thermosettable resins. The adhesive is reported to exhibit good adhesion in the thermally cured state to oily cold rolled steel. The thermosettable resins are preferably cured by amine type hardeners at a temperature of, for example, 150° C. for 30 min (see test procedure D).

PCT application No. WO98/21287 makes reference to thermosettable adhesives which are obtained by a mixture of a precursor and epoxy resins. The precursor is made by photopolymerized monomeric or prepolymeric syrup of ethylenically unsaturated components. Thermal curing is applied to thermoset the adhesive. This invention makes use of amine type hardeners that can be activated at temperatures lower than 100° C. Typical onset of hardening temperature as described in examples 1-4 is 70° C. at a minimum time period of curing of 30 minutes.

In order for one of ordinary skill in the art to presently bond substrates together in an attempt to achieve the desired benefits mentioned above, conventional liquid or thermoplastic hot melt adhesives must be employed. However, such adhesives suffer from numerous disadvantages.

Liquid adhesives may damage the sensitive active components of the device due to VOC's present therein, the adhesive must be sprayed or rolled onto the substrate, it is difficult to maintain a well-defined bondline and thickness, expensive dispensing equipment must be employed, mechanical fasteners must be used to hold the substrate in place until the adhesive sets, such adhesives are generally not flexible and have poor flex resistance, and expertise is required to deal with the potential hazards of the materials.

Thermoplastic hot melt adhesives require expensive sophisticated equipment to deliver the hot melt, mechanical fasteners are required to hold the substrate in place, the material has poor heat resistance, the potential for burns or other hazards exists, the high temperatures required may be hazardous to electronic devices, and cannot be used with heat sensitive materials.

The transformable adhesives of the present invention offer numerous benefits over liquid and hot melt adhesives. Advantageously, the adhesive may initially be employed in the form of a conventional pressure sensitive adhesive. This means the material has quick adhesion capable of holding substrates together while avoiding the need to use mechanical fasteners for extended periods of time. The adhesive can be provided in single, double faced (between two release liners), or transfer films (on a single release liner), which can be easily and safely applied by hand or machine. This renders the area and extent of application of the adhesive predictable. The adhesive is viscoelastic, remains latent and will not react until triggered by an external source such as UV, heat or visible light. Therefore, the adhesive is not messy and contains extremely low levels of VOC's, if any. Once applied, the adhesive has sufficient green strength to maintain the bond for an extended period of time.

Second, upon exposure to an external trigger, the adhesive transforms its physical and chemical nature, exhibiting the mechanical strength, chemical resistance, moisture and gas permeability, necessary to attain the above desired results. Therefore, the transformable adhesive of the present invention provides the user with the ability to achieve the above mentioned benefits without the attendant disadvantages and hazards of liquid and hot melt adhesives.

In addition to overcoming the prior difficulties of working with liquid and hot melt adhesives, the transformable pressure sensitive adhesives of the present invention offer advantages over heat curable thermosetting adhesives. Heat curable adhesives require high temperatures and/or long cure times. Heat cure systems can take up to 3 hours and temperatures as high as 300° F. Therefore, heat cured systems are not acceptable for heat sensitive substrates, such as polypropylene, HDPE, certain PETs, etc., that can be damaged at elevated temperatures. Heat can also damage the active components.

The transformable adhesives of the present invention react extremely fast and at ambient temperatures or at slightly elevated temperatures. Cure times can be as short as a few seconds and occur at room temperature.

In prior approaches, use has been made either of a traditional pressure sensitive adhesive or a liquid adhesive. As discussed above, use of either one is accompanied by certain disadvantages. Pressure sensitive adhesives have been used in bonding because they are easy to use and result in instant bond formation. It is generally available in tape or transfer film form in well defined thickness. However, these have moderate load bearing and temperature resistance capability. When used for sealing it has a limited resistance to solvents, liquids and gases. When used for splicing it has moderate thermal and shear resistance. The traditional pressure sensitive adhesive does not provide the degree of chemical resistance required in some diagnostic device assembly applications. It also results in gumming up of the cutting die and slows down productivity. It does not provide an adequate seal during the expected lifetime of the electronic device. Also, traditional pressure sensitive adhesives may have a tendency to creep when exposed to elevated service temperatures, such as those in a car, thereby compromising the bond.

Hot melt adhesives and certain thermosetting adhesives, like transformable pressure sensitive adhesives, can be made as free standing films. However, hot melts typically lack the tack necessary to immediately wet out and adhere to the substrate surface. Elevated temperatures are needed to bond the substrates. Also, hot melts normally require fasteners during heating to lessen the possibility of substrate shifting during the heat-bonding step. Thermosetting adhesives can also function as pressure sensitive adhesives prior to thermal triggering. However, an important difference between thermosetting pressure sensitive adhesives and transformable pressure sensitive adhesives is the method of cure. Thermosetting pressure sensitive adhesives require a heat source to cure thermosetting pressure sensitive adhesives to limit their use in markets that require the bonding of heat sensitive substrates. The transformable pressure sensitive adhesives remain latent and will not react until triggered by an external source such as UV or visible light source.

Furthermore, bonding of temperature sensitive substrates such as plastic substrates requires sufficiently low curing temperatures of the transformable pressure sensitive adhesive in order to avoid damaging the substrate during the curing reaction. The temperature sensitive active components of the device are also susceptible to damage at curing temperatures above 60° C. The curing temperatures generally reported in the prior art are too high for applications contemplated in the present invention. Also, the minimum cure time needed for cure is 30 minutes, with a longer cure time being required at lower temperatures. Therefore, there is a need for a transformable pressure sensitive adhesive having an onset temperature for the curing reaction of no more than 60° C. with a heat exposure of less than 10 minutes. Preferably, a “cold” UV cure with a cure time of less than 5 minutes is employed.

By way of further disadvantage, the acrylate-containing monomeric or prepolymeric syrup described in the prior art have softening points below room temperature and, therefore, do not provide the mechanical properties which are required to meet all the practical requirements to a sufficient and/or desirable degree. When a thermosetting tape based on monomeric or prepolymeric syrup is cured, it shrinks. The shrinking force is high enough to cause interfacial delamination of the tape from the substrate. Delamination compromises the integrity of barrier and solvent resistance of the bond. The higher the monomeric and prepolymeric content, the higher will be the shrinkage. Instead, starting with a polymer with a softening point greater than 60° C. results in reduced shrinkage upon curing. Therefore, an improved interfacial bond is formed with higher mechanical strength and improved solvent resistance and barrier properties.

When the adhesive bond is also used for hermatic sealing to protect against the atmospheric elements, the choice of acrylate-based monomeric and prepolymeric syrups is not the best one either. Acrylates are not known for barrier or solvent resistance properties, and accordingly are not suitable candidates for proper protection of display screens and photochromic windows.

In accordance with the present invention, a transformable pressure sensitive adhesive composition is provided comprised of: (a) from about 15% to about 80% by weight (preferably 20% to 50% by weight) of a polymer having a softening point greater than 60° C.; (b) from about 20% to about 85% by weight (preferably 50% to 80% by weight) of a polymerizable resin with a softening point less than 30° C.; and (c) from about 0.5% to about 12% by weight of a latent initiator to trigger the reaction.

Optionally, a crosslinking agent may be present to increase the cohesivenss of the transformable pressure sensitive adhesive film. Typical crosslinkers include but are not limited to isocyanate, azirdine, and organometallic compounds. One of ordinary skill in the art can readily select a suitable crosslinking agent for use in the present invention.

The polymer having a softening temperature greater than 60° C. may be selected from a wide variety of polymers. Suitable polymers include but are not limited to polyurethane, poly(isobutylene), poly(acrylonitrile butadiene), polyvinylidene chloride, aromatic liquid crystalline polymer, copolymer of ethylene norbornene, poly(meth)acrylate, polycarbonate, polyester, polycaprolactone, polysulfone, polyphenylene oxide resins, phenolic resins, and phenoxy resins.

The polymerizable resin of the present invention having a softening point less than 30° C. may also be selected from a wide variety of resins. Such resins include but are not limited to resins containing the following functionalities; epoxy, (meth)acrylate, thiolene, hydroxy, carboxy, vinyl, vinyl ether, etc. The polymerizable resins can be monofunctional, difunctional, or multifunctional, depending upon the degree of crosslinking that is desired and the ultimate physical properties of the transformable adhesive. Examples of such resins are the glycidyl ethers of alcohols and phenols. The acrylated glycidyl ether of bisphenol A is also suitable for use in the invention.

A variety of latent initiators may be employed, including a free radical and/or onium salt cationic photoinitiator.

Useful photoinitiators can be further classified as free radical photoinitiators and cationic photoinitiators. The choice of initiator will depend on the chemistry of the adhesive, with such selection being within the skill of the routineer in the art. The free radical photoinitiators include but are not limited to the alpha cleavage ketone family such as benzoin ethers, benzil ketals and acetophenones. Hydrogen abstraction photoinitiators such as benzophenone, thioxanthones, and camphorquinones may also be used. The cationic photoinitiators include but are not limited to onium salt photoinitiators of the formula Ar⁺MF₆ wherein Ar is a mixed aryl sulfonium of mixed aryl iodonium and M is phosphorous, arsenic or antimony. Exemplary photoinitiators include triarylsulfonium complex salts (as disclosed by U.S. Pat. No. 4,231,951); aromatic sulfonium or iodonium salts of halogen-containing complex ions (as disclosed by U.S. Pat. No. 4,256,828); and aromatic onium salts of Group IVA elements (as disclosed by U.S. Pat. Nos. 4,058,401 and 4,138,255). Typically, photoinitiators will be present in an amount of from about 0.25% to 30% by weight.

The composition of the present invention may be prepared by mixing the resin and the latent initiator in the polymer having a softening temperature of greater than 60° C. The ingredients can be dissolved in a suitable solvent to facilitate mixing. The mixture is then applied on a film substrate such as a polyester sheet or a release liner. If required, the coated sheet is placed in an oven to remove the solvent. The ratio of the high molecular weight polymer and the resin are adjusted so that the resulting coating behaves as a pressure sensitive adhesive. The performance properties of the pressure sensitive adhesive can be transformed on exposure to a suitable trigger such as UV, visible light or heat.

Alternatively, the ingredients can be mixed in a heated high shear mixer such as a kneader or extruder without the use of solvents.

Fillers such as silicas, wood fibers, calcium carbonate and the like can be used to mechanically reinforce the adhesive composition by providing increased shear and tensile strength. Nickel, steel flakes, silver coated glass spheres, carbon black, and the like can be used to make the composition electrically conductive. Alumina, boron nitrate, and the like can be used to make the composition thermally conductive. Halogens, phosphates, melamine based compounds, and certain heavy metal containing species, such as antimonate, may be added to the adhesives composition to provide flame-retardant films. Nanoparticle silicas and nanoparticle montmorollonite clays may also be used as fillers for decreasing moisture permeability through the adhesive film.

Various amounts of fillers can be employed, subject to the following considerations. The filler loading cannot exceed an amount that does not allow the material to behave as a pressure sensitive adhesive. For example, after high loading of calcium carbonate or wood fibers, the pressure sensitive adhesive may no longer have sufficient tack. It is also important that the loading of the filler not exceed an amount that renders the material so opaque that UV or visible light is unable to penetrate the adhesive such that the desired transformation cannot occur. However, in the event that a non-UV or visible light trigger is employed (such as electron beam or heat), then larger amounts of filler loading may be employed.

The transformation of the pressure sensitive adhesive of the present invention can triggered by irradiation with UV and visible light. Alternatively, the transformation may be triggered by heat. Proton scavengers including alkene oxides such as polyethylene glycol and polypropylene glycol may be added to the adhesive composition to delay the cure in cationically cured UV adhesives. This provides increased open tack time for bonding after exposure to UV. Delayed cure systems are attractive for bonding substrates whereby the trigger is blocked from reaching the adhesive. The amount of loading of alkene oxides will depend on the amount of open tack time that is desired after transformation of the adhesive is triggered. However, the higher the loading of the alkene oxides is, the more flexible and less strong is the adhesive after being transformed. Typically, alkene oxides will be added in an amount of from 1 to 10% by weight of total solids.

Photosensitizers such as anthracene and perylene may be incorporated into the formulations to allow UV adhesives to cure under visible light or to extend the wavelength range required for curing.

The adhesive composition may also contain a variety of tackifying resins, plasticizers, adhesion promoters and other reinforcing polymers in order to adjust the Theological profile of the composition to promote adhesion. Adhesion promoters such as, for example, titanates, zirconates, and silane coupling agents may be incorporated into the adhesive formulation to improve adhesion to glass and metal substrates. Such materials are generally added in an amount of from 0.25-3% by weight, based on total solids, The use of certain mono, di, and trifunctional acrylates and epoxies, such as SR 203 from Sartomer, may be incorporated in the composition to swell certain plastic substrates and improve overall adhesion. Mono-, di- and trifunctional acrylates and epoxies are added at higher amounts than the titanates, zirconates, and silicone coupling agents. The loading of the respective adhesion promoters is limited by the effect upon pressure sensitive adhesive properties. For example, Sartomer 203 is a low viscosity material that plasticizes the adhesive. At high loading, the material may plasticize the adhesive to a degree such that it can no longer function as a pressure sensitive adhesive. A typical loading for such a material would be in the range of from 5 to 50% by weight, based on total solids.

The invention is further described in connection with the following examples.

### EXAMPLE 1

### UV Triggered Pressure Sensitive Adhesive Tape

Formulations for samples 1 and 2 were prepared by mixing polymers having a softening temperature greater than 60° C., functionalized resins, and latent initiators in an organic solvent (ethyl acetate). The ethyl acetate content was adjusted in the formulation to dissolve the components so that a coatable viscosity was obtained. The samples were mixed on a Ross mixer at approximately 2300 rpm until a homogenous mixture was obtained. The samples were allowed to roll on a rollermill overnight to allow air bubbles to settle out of the solution. The formulations were coated onto 50 micron polyester film using a bench coater, consisting of two stainless steel coating bars and nips to control the thickness of the coating. The samples were placed in drying ovens to remove residual solvent from the samples. After drying, all samples were protected with a 50 micron silicon release liner and stored in an aluminum foil bag until testing. The respective compositions of Samples 1 and 2 are identified below in Table 1:

TABLE 1
Composition of Samples 1 and 2

| Adhesive Component | Sample 1 | Sample 2 |
|---|---|---|
| Gelva 788 | 49.63 | 0 |
| AS 140 | 0 | 19.79 |
| Epon 58005 | 0 | 29.69 |
| Ebecryl 3605 | 49.63 | 49.79 |
| Irgacure 184 | 0.25 | 0.25 |
| UVI 6976 | 0.49 | 0.78 |
| Anthracene | 0 | 0.02 |

Note:
Gelva 788 = acrylic PSA with epoxy and hydroxy functionality
AS 140 = high Tg acrylic polymer with low epoxy equivalent
Epon 58005 = rubber modified Bis A epoxy oligomer
Ebecryl 3605 = epoxidized Bis A diacrylate
Irgacurre 184 = photoinitiator
UVI 6976 = triaryl sulfunium hexafluoroantimonate cationic initiator
Anthracene = photosensitizer

Lap shear joints were made using adhesives of Samples 1 and 2 on the substrates identified in the table below. The adhesive was cured by UV irradiation. The strength of the lap joints was measured on each formulation to demonstrate the strength of the transformable pressure sensitive on various types of substrates. The lap shear strength results are summarized in Tables 2 and 3 below, with Table 2 including for comparison various prior art adhesives):

TABLE 2
Lap Shear Strength Results (Comparison with Prior Art)

| Substrate | Adhesive | Lap Shear Strength |
|---|---|---|
| SS/SS | 3M VHB Transfer Film | 100 psi |
| SS/SS | Acrylic PSA | 140 psi |
| SS/SS | Loctite Hot Melt adhesive | 270 psi |
| SS/SS | 3M heat activated PSA | 1150 psi |
| PET/PET | 3M heat activated PSA | 500 psi** |
| SS/SS | Loctite 2 part epoxy | 1625 psi |
| Glass/SS | Sample 1 | >1000 psi |
| Glass/SS | Sample 2 | >1000 psi |
| Glass/PET | Sample 2 | 800 psi* |

Note:
SS = stainless steel
PET = polyethylene terephthalate (polyester)
*= glass substrate broke
**= PET failure

TABLE 3
Lap Shear Strength Results (Present Invention)

| Substrate | Sample 1 | Sample 2 |
|---|---|---|
| Glass/glass | 848 psi | >1000 psi |
| Glass/aluminum | 810 psi | 1000 psi* |
| Glass/steel | 896 psi | >1000 psi |
| Glass/acrylic | 400 psi | 800 psi* |
| Glass/polycarbonate | 360 psi | not tested |
| Glass/ABS | 360 psi | not tested |
| Glass/polyester | did not test | 800 psi* |

Note:
*substrates were acid etched using chromic acid solution to improve adhesion to aluminum, acrylic and polyester. Lap shear samples were 0.5″ × 0.5″ overlap bonds between glass and second substrate. The adhesive was applied first to the glass side and then against the second surface. The samples were heated at 80° C. for 30 seconds and UV cured.

Table 2 depicts the lap shear strength of Samples 1 and 2 of the present invention in relation to several representative prior art adhesives. As is expected, the transformable pressure sensitive adhesive of the present invention outperforms many typical adhesives with respect to lap shear strength. While epoxy and heat activated adhesives are also shown to exhibit high lap shear strengths, such adhesives are either liquid (epoxy) or require elevated temperatures for curing. The transformable adhesives of the present invention avoid the disadvantages associated with epoxy and or heat-activated adhesives may accordingly be avoided by the use of the transformable adhesives of the present invention.

The transformable adhesives of the present invention are shown in Table 3 to exhibit excellent adhesion to a variety of substrates, such as glass/glass, glass/plastic and glass/metal.

### EXAMPLE 2

### UV Triggered Pressure Sensitive Adhesive Tape

Epoxidized poly(acrylonitrile butadiene) polymer was dissolved in ethyl acetate at 40% solids. The functionalized resins and latent initiators were added to the formulation. The samples were mixed on a Ross mixer at approximately 2300 rpm until a homogenous mix was obtained. The samples were allowed to roll on a rollermill overnight to allow air bubbles to settle out of the solution. Formulations were coated onto 50 micron polyester film or release liner using a bench coater, consisting of two stainless steel coating bars and nips to control thickness. Samples were placed in drying ovens to remove solvent. After drying, all samples were protected with 50 micron silicon release liner and stored in an aluminum foil bag until testing. The specific formulations used for Samples 3 and 4 are identified in Table 4 below:

TABLE 4
Composition of Samples 3 and 4

| Adhesive Component | Sample 3 | Sample 4 |
|---|---|---|
| Epoxidized poly(acrylonitrile | 19.76 | 18.94 |
| butadiene) | | |
| Epon 834 | 39.52 | 37.88 |
| Epon 828 | 9.88 | 9.47 |
| UVI 6976 | 1.20 | 5.30 |
| Ethyl acetate | 29.64 | 28.41 |

Note:
Epoxidized poly(acrylonitrile butadiene) = epoxy modifed polymer
Epon 834 = Bis A epoxy oligomer
Epon 828 = Bis A epoxy oligomer
Irgacure 184 = photoinitiator
UVI 6976 = triaryl sulfunium hexafluoroantimonate cationic initiator

Bonds were made with the Samples 3 and 4 and the adhesive cured by exposure to UV radiation. Test data on the strength and solvent resistance is summarized in Table 5 below:

TABLE 5
Performance Results

| T-peel | Sample 3 | Sample 4 |
|---|---|---|
| Melinex 453/Melinex 453 | | |
| 5 mil film | adhesive failure | film failure |
| Polypropylene/Polypropylene | | |
| 2 mil corona treated film | did not test | film failure |
| MDPE/MDPE | | |
| 2 mil corona treated film | did not test | film failure |
| MEK Wipe Test | 44 wipes | 400+ wipes |
| | | (did not fail) |
| Lap Shear Test | | |
| Glass/Glass | 696 psi | 317.6 psi |
| Note: | | |
| T-peel samples were prepared by sampling the UV pressure sensitive adhesive between two films. Samples were then UV cured. Samples were allowed to post cure for 5 minutes. After 5 minutes, T-peels were performed on samples at 12 in/min. MEK wipe samples were prepared by placing UV pressure sensitive adhesives onto a 5 mil Melinex film and UV curing the material. The samples were allowed to post cure for 5 minutes. | | |
| # After 5 minutes, MEK wipe tests were performed on all samples. Lap shear samples were 0.5″ × 0.5″ overlap bonds between glass and glass. The adhesive was applied first to the glass side and then against the glass surface. The samples were heated at 80° C. for 30 seconds and UV cured. | | |

The transformable pressure sensitive adhesive of Samples 3 and 4 are designed to bond flexible substrates. The requirements for such adhesives are adequate adhesion, cohesive strength, as well as chemical, moisture and gas resistance. The level of adhesion to the flexible substrates can be determined by performing T-peel tests, with the transformable pressure sensitive adhesive being cured between the two films. The values demonstrate that the peel strength exceeded the strength of the substrates as confirmed by the film failure. MEK wipe is a test for solvent resistance of the coating. It can be seen that Sample 4 was intact even after 400 wipes. A lap shear of 317 psi was obtained in a glass/glass bond which is a significant improvement over a traditional pressure sensitive adhesive. Overall, a good balance of properties is demonstrated to exist.

The transformable pressure sensitive adhesive of the present invention has particular applicability in the formation of optical display devices, such as organic light emitting diode (OLED) devices. OLED devices are monolithic, thin film, semi-conductor devices that emit light when voltage is applied to the device. Simply, the OLED device consists of multiple organic thin films that are sandwiched between two thin-film conductors. Such devices may be manufactured on rigid substrates such as glass or silicon, or flexible substrates such as plastic. While these devices have found recent acceptance in the industry, the lifetime of the device is of concern. Exposure to moisture, oxygen and other contaminants drastically reduces the lifetime of the device.

In an attempt to minimize the effect of such contaminants, the devices are typically manufactured on the desired substrate, with the device then being enclosed or encapsulated within a cover of glass, plastic or metal. The perimeter of the cover is sealed to the device and an inert atmosphere (such as nitrogen) maintained in the enclosed space above the device. Dessicants (or “getters”) are typically placed in the enclosure as additional protection against chemicals, outgassing from conventional encapsulation adhesives and any moisture or oxygen that may find its way into the enclosed space above the device. It has also been found useful to place a monolithic coating on top of the device to provide further protection from any contaminants that may reside in the sealed space.

The perimeter of the cover is typically sealed to the device by means of a suitable adhesive such as an epoxy resin. It is important that the sealing adhesive be low out-gassing to minimize the presence of organic contaminants within the sealed space. It is also important for the adhesive to be cured in a manner that will avoid damage to the device. In this regard, the use of high curing temperatures for the adhesive is, of course, to be avoided.

The use of plastic substrates results in further complications from the standpoint of possible contamination and reduced useful life for the device. Plastic substrates are especially useful in those embodiments where a flexible device is desired, as rigid glass substrates would be unsuitable for such a purpose. However, plastic substrates are more permeable than glass substrates (thus serving as a poor barrier to moisture and contaminant gases), and thus more susceptible to contamination of the enclosed space. An additional problem that occurs with respect to the use of plastic substrates is that the edge sealing materials do not bond as well to plastic as to glass. Such edge barrier materials also may not maintain their sealing edge bond upon the flexing or bending of the device.

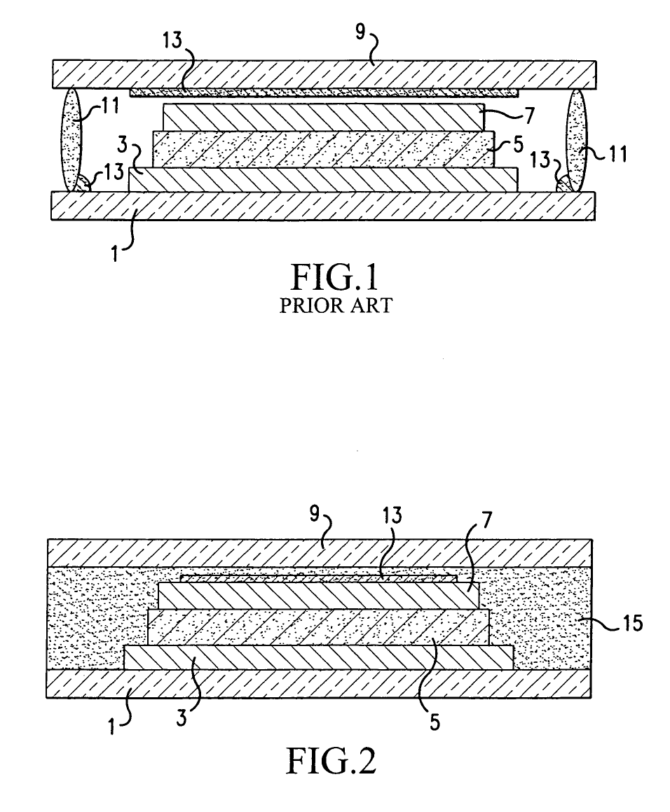

A typical prior art OLED device is depicted in FIG. 1 in cross section. In FIG. 1, substrate 1 is comprised of a suitable material such as glass, silicon or plastic. On top of the substrate are formed the bottom conductive electrode 3, the organic stack 5 and the top conductive electrode 7. Cover 9 is then placed over the electrodes 3, 7 and the organic stack 5. While shown in the drawing as a unitary layer, the organic stack in actuality will comprise multiple layers. For instance, the organic stack will typically comprise (from the top to the bottom) an electron-transporting layer, a light-emitting or emissive layer, and a hole-transporting layer. Such layers are conventional in the art and accordingly are not specifically shown in FIGS. 1 and 2. The respective layers may also be stacked within the device (not shown in the Figures) to enable a variety of colors to be emitted at the same time.

The cover may also be comprised of any suitable material such as glass or plastic. The cover is bonded to the substrate 1 by means of a perimeter seal 11 which is comprised of a suitable sealing material such as an epoxy adhesive. A “getter” material 13 may be placed within the sealed space to remove any contaminants that may enter the sealed space. The “getter” material may be placed, for example, in a corner or along a portion of the bottom of the cover.

In operation, negative charge carriers (electrons) and positive charge carriers (called “holes” meaning the absence of an electron) are injected from the cathode and anode, respectively. The carriers are transported to the light-emitting layer under the influence of an electrical field, where the negative and positive charge carriers associate with one another to form an “exciton”. The “exciton” decays very rapidly to provide light of a particular energy to yield a color. Depending upon the organic molecules which are present in the light-emitting layer, red, green or blue light can be produced and emitted. At least one of the cathode or anode must be transparent for the light to be visible.

However, as discussed above, the prior art has experienced problems in connection with the perimeter seal 11 not providing a satisfactory barrier for the sealed space, as well as not being sufficiently “clean” whereby off-gassing from the material itself becomes a contaminant. The use of plastic substrates further complicates this issue, for the reason that plastic substrates are not as effective in serving as a barrier as glass substrates.

It has been found, however, that all of the above problems may be successively addressed by filling the enclosed space between the substrate and the cover with a material that serves as a permanent barrier to contaminants, does not suffer from off-gassing of contaminants, and exhibits sufficient flexibility to function in a flexible OLED device. The novel transformable pressure sensitive adhesive of the present invention has been found to function satisfactorily in such an environment, thus successfully overcoming problems not previously overcome by the prior art.

In the context of the present invention, an improved OLED device would thus be formed as depicted in FIG. 2. FIG. 2 depicts in cross-section the novel OLED device of the present invention. In the Figure, substrate 1 may, as before, be comprised of a suitable substrate such as glass, silicon or plastic. On top of the substrate are formed the bottom electrode 3, the organic stack 5 and the top electrode 7. The transformable pressure sensitive adhesive material 15 is then placed in encompassing relationship to the electrodes and organic layers. In effect, the entire interior of the OLED device is encapsulated in the thermoformable pressure sensitive adhesive material prior to the cover being placed over the device and held in place by the adhesive layer. As the entire interior space of the device is now taken up by the adhesive layer, it is no longer necessary to employ a perimeter seal. While the presence of a “getter” material is no longer required, it is still possible to incorporate a “getter” material 13 within the device and encapsulated within the adhesive as shown in FIG. 2 as additional protection.

Alternatively, the getter (or desiccant) material can be incorporated into the adhesive itself to further improve the performance of the OLED seal. Exemplary getter or desiccant materials (materials that consume free water or moisture present in the system) include but are not limited to common dessicant materials such as silica, silica-gel, alumina, molecular sieve materials, sodium sulfate, and zeolites that rely on the physical adsorption of the moisture to eliminate moisture buildup. Another class of desiccants rely on chemical reaction with water to eliminate moisture. These desiccants can be incorporated into the adhesive also, and include but are not limited to alkoxysilanes, vinyl trimethoxysilane, oxazolidines, isocyanates, p-toluenesulfonyl isocyanate, barium oxide, phosphorus pentoxide, calcium oxide, metallic calcium, metal hydrides, calcium hydride, alkali and alkaline earth metals and oxides thereof. These materials can be incorporated into the adhesive in the same manner as filler materials according to known techniques in the art.

Once the cover is placed on the top of the device and caused to adhere to the adhesive layer, the adhesive may then be “transformed” by application of a suitable trigger such as UV, heat or visible light. The interior adhesive layer is then “transformed” from a pressure sensitive adhesive layer to a structural adhesive which encapsulates the functional layers of the OLED device and sealing such layers from contamination from harmful contaminants. Advantageously, the adhesive may be transformed by application of non-detrimental UV or visible light radiation, while avoiding the application of heat to the sensitive OLED device.

The adhesive of the present invention may also be used with advantage in other types of devices, such as LCD's, LED'S, plasma display devices, electrochromic devices, and medical diagnostic testing devices.

For example, LCD's and LED's typically use epoxy-based adhesives to form a perimeter seal around the display device. However, the use of such adhesives is not without disadvantage. For instance, liquid adhesives in such an environment suffer from the disadvantages discussed above. The epoxy-based adhesives are also too brittle for use with flexible displays. The adhesives of the present invention may accordingly be used in place of liquid adhesives conventionally used as perimeter seals in such devices. As with the OLED displays, the transformable adhesive of the present invention can be placed along the perimeter of the device and subsequently transformed by application of UV or visible light to form a barrier seal along the periphery of the device.

The adhesives of the present invention will also have applicability in medical diagnostic devices, such as those comprised of a plastic housing and a diagnostic test strip in the housing. The use of such adhesives in these devices will provide enhanced barrier properties as well as reducing any problems that may normally occur during manufacture of the device that may result from the presence of a conventional pressure sensitive adhesive (due to the reduced tack of the adhesive after being transformed).

What is claimed is:

1. A transformable pressure sensitive adhesive composition comprised of:
(a) from about 15 to about 80% by weight of a polymer having a softening point greater than 60° C.;
(b) from about 20 to about 85% by weight of a polymerizable resin having a softening point less than 30° C.;
(c) a latent initiator in an amount sufficient to cause a reaction between said polymer and said resin; and
(d) optionally, a crosslinking agent.

2. The composition of claim 1, wherein said polymer is selected from the group consisting of polyurethane, poly(isobutylene), poly(arylonitrile butadiene), polyvinylidene chloride, aromatic liquid crystalline polymers, copolymers of ethylene norbornene, poly(meth)acrylate, polycarbonate, polyester, polycaprolactone, polysulfone, polyphenylene oxide resins, phenolic resins, and phenoxy resins.

3. The composition of claim 1, wherein said resin is an epoxy resin.

4. The composition of claim 3, wherein said epoxy resin is a glycidyl ether of alcohol and phenol.

5. The composition of claim 1 wherein the latent initiator is a free radical and/or onium salt cationic photoinitiator.

6. The composition of claim 1 further comprising nanoclays in an amount of from 1 to 20% by weight.

7. The composition of claim 1 further comprising a desiccant material.

8. The composition of claim 1 further comprising at least one material selected from the group consisting of tackifying resins, plasticizers, fillers or reinforcing polymers.

9. The composition of claim 1, further including a crosslinking agent.

10. The composition of claim 9, wherein said crosslinking agent is selected from the group consisting of isocyanates, aziridines, and organometallic compounds.

11. The composition of claim 1, wherein said polymer is an acrylate.

12. In an organic light emitting diode display device, comprised of a substrate, two electrodes, organic stack between said electrodes, and a cover for said device, the improvement wherein said electrodes and organic stack are encapsulated in a transformed pressure sensitive adhesive which serves as a barrier layer for moisture and other contaminants, said transformed pressure sensitive adhesive being applied in the form of a pressure sensitive adhesive comprised of from (a) about 15 to about 80% by weight of a polymer having a softening point greater than 60° C.; (b) from about 20 to about 85% by weight of a polymerizable resin having a softening point less than 30° C.; (c) a latent initiator in an amount sufficient to cause a reaction between said polymer and said resin; and (d) optionally a crosslinking agent, with said adhesive subsequently being transformed upon application of a suitable trigger to transform said adhesive by activation of said latent initiator.

13. In a light emitting diode display device, the improvement wherein the perimeter seal of said device is comprised of a transformed pressure sensitive adhesive which serves as a barrier layer for moisture and other contaminants, said transformed pressure sensitive adhesive being applied in the form of a pressure sensitive adhesive comprised of from about 15 to about 80% by weight of a polymer having a softening point greater than 60° C.; (b) from about 20 to about 85% by weight of a polymerizable resin having a softening point less than 30° C.; (c) a latent initiator in an amount sufficient to cause a reaction between said polymer and said resin, and (d) optionally, a crosslinking agent, with said adhesive subsequently being transformed upon application of a suitable trigger to transform said adhesive by activation of said latent initiator.

14. In a medical diagnostic testing device, comprised of a plastic housing and a diagnostic test strip in the housing, the improvement wherein said device includes a transformed pressure sensitive adhesive, said transformed pressure sensitive adhesive being applied in the form of a pressure sensitive adhesive comprised of (a) from about 15 to about 80% by weight of a polymer having a softening point greater than 60° C.; (b) from about 20 to about 85% by weight of a polymerizable resin having a softening point less than 30° C.; (c) a latent initiator in an amount sufficient to cause a reaction between said polymer and said resin, and (d) optionally a crosslinking agent, with said adhesive subsequently being transformed upon application of a suitable trigger to transform said adhesive by activation of said latent initiator

15. In a flexible or rigid LCD display device, the improvement wherein the perimeter seal of said device includes a transformed pressure sensitive adhesive, said transformed pressure sensitive adhesive being applied in the form of a pressure sensitive adhesive comprised of (a) from about 15 to about 80% by weight of a polymer having a softening point greater than 60° C.; (b) from about 20 to about 85% by weight of a polymerizable resin having a softening point less than 30° C.; (c) a latent initiator in an amount sufficient to cause a reaction between said polymer and said resin, and (d) optionally a crosslinking agent, with said adhesive subsequently being transformed upon application of a suitable trigger to transform said adhesive by activation of said latent initiator.

16. In a plasma display device, the improvement wherein the perimeter seal of said device includes a transformed pressure sensitive adhesive, said transformed pressure sensitive adhesive being applied in the form of a pressure sensitive adhesive comprised of (a) from about 15 to about 80% by weight of a polymer having a softening point greater than 60° C.; (b) from about 20 to about 85% by weight of a polymerizable resin having a softening point less than 30° C.; and (c) a latent initiator in an amount sufficient to cause a reaction between said polymer and said resin, and (d) optionally a crosslinking agent, with said adhesive subsequently being transformed upon application of a suitable trigger to transform said adhesive by activation of said latent initiator.

17. In an electrochromic device, the improvement wherein the perimeter seal of said device includes a transformed pressure sensitive adhesive, said transformed pressure sensitive adhesive being applied in the form of a pressure sensitive adhesive comprised of (a) from about 15 to about 80% by weight of a polymer having a softening point greater than 60° C.; (b) from about 20 to about 85% by weight of a polymerizable resin having a softening point less than 30° C.; (c) a latent initiator in an amount sufficient to cause a reaction between said polymer and said resin, and (d) optionally a crosslinking agent, with said adhesive subsequently being transformed upon application of a suitable trigger to transform said adhesive by activation of said latent initiator.

18. The device of any one of claims 12-17 wherein said adhesive has been transformed by application of a suitable trigger to activate said latent initiator.

19. The device of any one of claims 12-17 wherein said adhesive includes a desiccant material.

20. The device of any one of claims 12-17 further including a crosslinking agent.

21. The device of claim 20, wherein said crosslinking agent is selected from the group consisting of isocyanates, aziridines, and organometallic compounds.

22. The device of any one of claims 12-17 wherein said polymer is an acrylate.

23. The device of any one of claims 12-17 wherein said polymer is selected from the group consisting of polyurethane, poly(isobutylene), poly(acrylonitrile butadiene), polyvinylidene chloride, aromatic liquid crystalline polymers, copolymers of ethylene norbornene, poly(meth)acrylate, polycarbonate, polyester, polycaprolactone, polysulfone, polyphenylene oxide resins, phenolic resins, and phenoxy resins.

24. The device of any one of claims 12-17, wherein said polymerizable resin is an epoxy resin.

25. The device of claim 24, wherein said epoxy resin is a glycidyl ether of alcohol and phenol.

26. The device of any one of claims 12-17 wherein the latent initiator is a free radical and/or onium salt cationic photoinitiator.

27. The device of any one of claims 12-17 further comprising nanoclays in an amount of from 1 to 20% by weight.

28. The device of any one of claims 12-17 further comprising at least one material selected from the group consisting of tackifying resins, plasticizers, fillers or reinforcing polymers.
